(19) United States
(12) Patent Application Publication
(10) Pub. No.: US 2020/0019776 A1
(43) Pub. Date: Jan. 16, 2020

(54) CURRENCY VERIFICATION AND TRANSACTION VALIDATION SYSTEM

(71) Applicant: Walmart Apollo, LLC, Bentonville, AR (US)

(72) Inventors: Steven Lewis, Bentonville, AR (US); Aaron Bartholomew, Noel, MO (US); Ian Stansell, Bentonville, AR (US)

(21) Appl. No.: 16/507,445

(22) Filed: Jul. 10, 2019

Related U.S. Application Data
(60) Provisional application No. 62/697,725, filed on Jul. 13, 2018.

(51) Int. Cl. G06K 9/00; G06N 20/00; G07D 5/00; G07D 7/202

(52) U.S. Cl. CPC G06K 9/00624; G06N 20/00; G07D 2207/00; G07D 7/202; G07D 2205/00; G07D 5/00

(57) ABSTRACT

Examples provide transaction validation through currency verification via computer vision and machine learning performed on images of non-currency and currency items from image capture devices associated with a currency environment. The results may be delivered by augmented reality (AR). Automation of currency verification and transaction validation during a transaction concludes the transaction more efficiently than manual verification and validation, increasing the amount of transactions per unit time. Examples using AR features can verify currency tendered and change made in real-time and identify foreign and counterfeit currency for removal. Examples incorporating AR features increase efficiency for fully-sighted providers and customers, while utilizing audio or braille output accommodates the visually impaired. Examples may indicate both what types and amounts of currency must be requested or discarded. Image analytics that verify correct tender and change is made in real time combined with AR provide unprecedented transaction efficiency.

### BACKGROUND

Whenever currency must be exchanged during a transaction between a customer and a provider of goods and/or services, both the customer and the provider prefer to conclude the transaction as quickly as possible. Inefficiency not only slows down each individual transaction, but also reduces the number of completed transactions over a given period of time. When a customer pays with currency, whose type and amount the provider must manually verify to validate and complete a transaction, such inefficiency increases dramatically. Manual verification and validation takes considerable time and may lead to further delays if the unsorted items given over by the customer to satisfy the transaction contain non-currency items that the provider must examine and discard.

### SUMMARY

Some examples provide a system for currency verification and transaction validation. The system includes a processor and a memory communicatively coupled to the processor. A currency identification component stored at the memory and executed by the processor obtains an image file from an image capture device associated with a currency environment. The currency identification component detects one or more items within the image file; verifies at least one currency item of the detected one or more items; analyzes the at least one verified currency item to identify a currency type and a currency value; and generates a currency verification report based on the verified currency type and the verified currency value. The generated currency verification report is outputted from the currency identification component to a transaction system for a currency calculation. The currency identification component receives the resulting currency calculation from the transaction system and performs a currency validation action based on the received currency calculation.

Other examples provide a computer-implemented method for currency verification and transaction validation. A currency identification component obtains an image file from an image capture device associated with a currency environment. Depending on the contents of the image file, the currency identification component detects one of: no items within the image file; one or more items within the image file, of which no items are currency items; or one or more items within the image file, of which at least one item is a currency item. When one or more items are detected, the currency identification component verifies at least one currency item of the detected one or more items; analyzes the at least one verified currency item to identify a currency type and a currency value; and generates a currency verification report based on the verified currency type and the verified currency value. The currency identification component outputs the generated currency verification report to a transaction system for a currency calculation and receives the currency calculation from the transaction system. Based on the received currency calculation, the currency identification component performs a currency validation action.

Still other examples provide one or more computer storage media, having computer-executable instructions for currency verification and transaction validation that, when executed by a computer, cause the computer to perform operations. These operations comprise obtaining, by a currency identification component implemented on a processor, an image file from an image capture device associated with a currency environment; detecting one or more items within the image file; verifying at least one currency item of the detected one or more items; analyzing the at least one verified currency item to identify a currency type and a currency value; and generating a currency verification report based on the verified currency type and the verified currency value. These operations further comprise outputting the generated currency verification report from the currency identification component to a transaction system for a currency calculation; and the currency identification component receiving the currency calculation from the transaction system. Based on the received currency calculation, the currency identification component performs a currency validation action.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for currency verification and transaction validation.

FIG. 2 is an exemplary block diagram illustrating the possible content of an image file.

FIG. 3 is an exemplary block diagram illustrating a system for performing currency verification and transaction validation via a user device.

FIG. 4 is an exemplary block diagram illustrating an image capture device.

FIG. 5 is an exemplary block diagram illustrating a currency environment.

FIG. 6 is an exemplary block diagram illustrating an augmented reality (AR) display.

FIG. 7 is an exemplary block diagram illustrating a machine learning component.

FIG. 8 is an exemplary flow chart illustrating operation of the computing device to perform currency verification and transaction validation.

FIG. 9 is an exemplary flow chart illustrating operation of the computing device to perform an appropriate currency validation action based on a currency calculation received from a transaction system.

FIG. 10 is an exemplary flow chart illustrating operation of the computing device to perform currency verification and transaction validation and to generate an audio output.

FIG. 11 is an exemplary flow chart illustrating operation of the computing device to perform currency verification and transaction validation and to store the output in a verification file.

FIG. 12 is an exemplary block diagram illustrating an operating environment for a computing device implementing developer environment.

Corresponding reference characters indicate corresponding parts throughout the drawings.

### DETAILED DESCRIPTION

Referring to the figures, examples of the disclosure provide transaction validation through currency verification with computer vision and machine learning functionality. Currency verification and transaction validation operations may be performed on captured images obtained from image capture device(s) associated with the currency environment. The images may contain mixed collections of non-currency items and currency items, and the generated output of such operations may be delivered via various output devices, including an augmented reality (AR) display, an audio-only output, and/or another user interface.

The elements described herein operate in an unconventional manner to allow for partial, complete, or near-complete automation of currency verification and transaction validation during a transaction between a provider of goods and/or services and a customer. Thus, the disclosure facilitates conclusion of the transaction as efficiently as possible, which in turn increases the amount of transactions which may be completed over a given unit of time. Delays that might otherwise arise from the provider having to manually sort and verify the items given over by the customer to satisfy the transaction are eliminated by the disclosure's ability to rapidly and accurately verify the presence and value of currency, identify and require the removal of non-currency, and prompt the customer and provider to take whatever actions are necessary to deliver sufficient currency to complete the transaction and, if necessary, deliver change to the customer. When necessary, the customer or provider may override the currency verification result when an item is not recognized as currency and indicate that that item is to be treated as a currency item with a specified value. Some examples of the disclosure provide video analytics that in some examples can verify that the correct amount and type of currency has been given by the customer and the correct amount of change has been returned by the provider in real-time.

Examples of the disclosure also improve transaction accuracy, by quickly identifying and generating a notification for removal of foreign currency or counterfeit currency that cannot be used to satisfy the transaction. Because examples of the disclosure are incorporated into various types of systems with a variety of output features, it is possible to incorporate AR features to increase efficiency for fully-sighted providers and/or customers, or to utilize an audio output or braille display to allow visually impaired providers and/or customers to accurately and efficiently complete the transaction. Because examples of the disclosure are configured to instruct the provider on both what types and amounts of currency must be requested from the customer to satisfy the transaction and also what types and amounts of currency must be returned to the customer when the customer has overpaid, the disclosure may also function as an efficient teaching tool for trainees learning how to quickly and efficiently make change during a transaction.

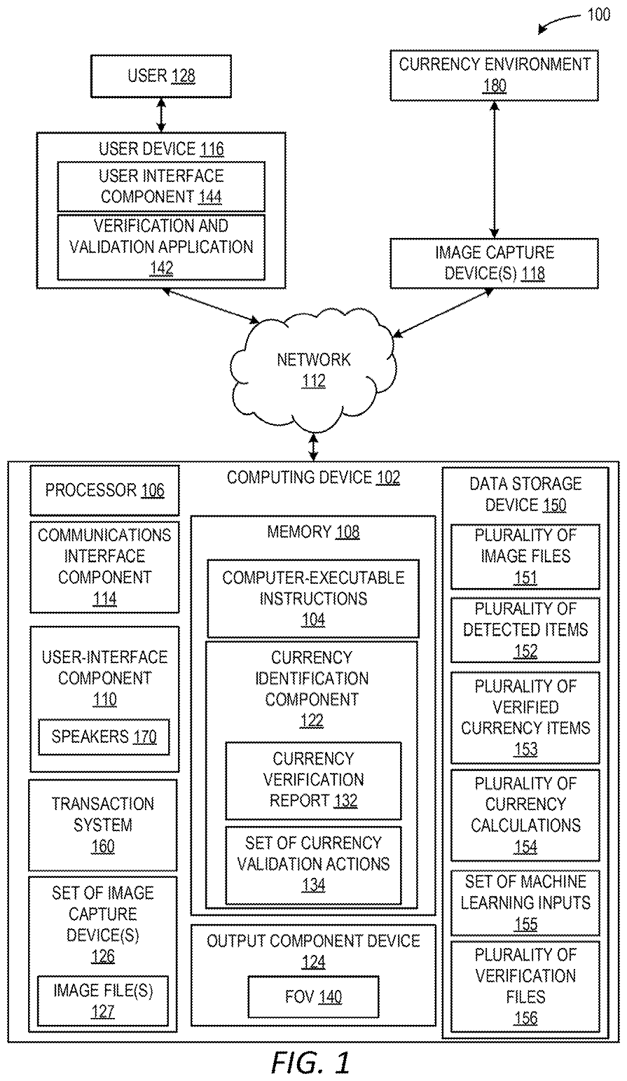

Referring again to FIG. 1, an exemplary block diagram illustrates a system 100 for currency verification and transaction validation of currency items in a currency environment 180. In the example of FIG. 1, a computing device 102 represents any device executing computer-executable instructions 104 (e.g., as application programs, operating system functionality, or both) to implement the operations and functionality associated with the computing device 102. The computing device 102 may include a mobile computing device or any other portable device. In some examples, the mobile computing device includes a mobile telephone, laptop, tablet, computing pad, netbook, gaming device, wearable device, and/or portable media player. The computing device 102 may also include less-portable devices such as servers, desktop personal computers, kiosks, or tabletop devices. Additionally, the computing device 102 may represent a group of processing units or other computing devices.

The currency environment 180 may also be referred to as a scene, viewing range, or picture. The currency environment 180 refers to the portion of the real world about which the system 100 may receive information in order to perform currency verification and transaction validation. In this example, that information is delivered in the form of an image file from at least one image capture device(s) associated with the currency environment 180 and capable of capturing still or video images of the currency environment 180.

In some examples, the computing device 102 has an at least one processor 106 and a memory 108. The computing device 102 may also include a user interface component 110.

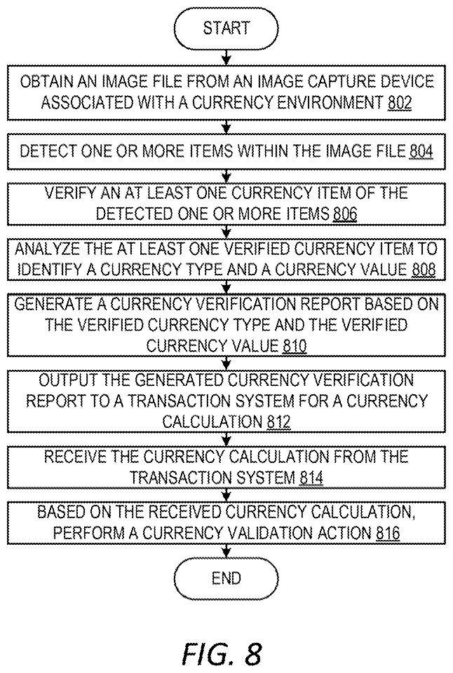

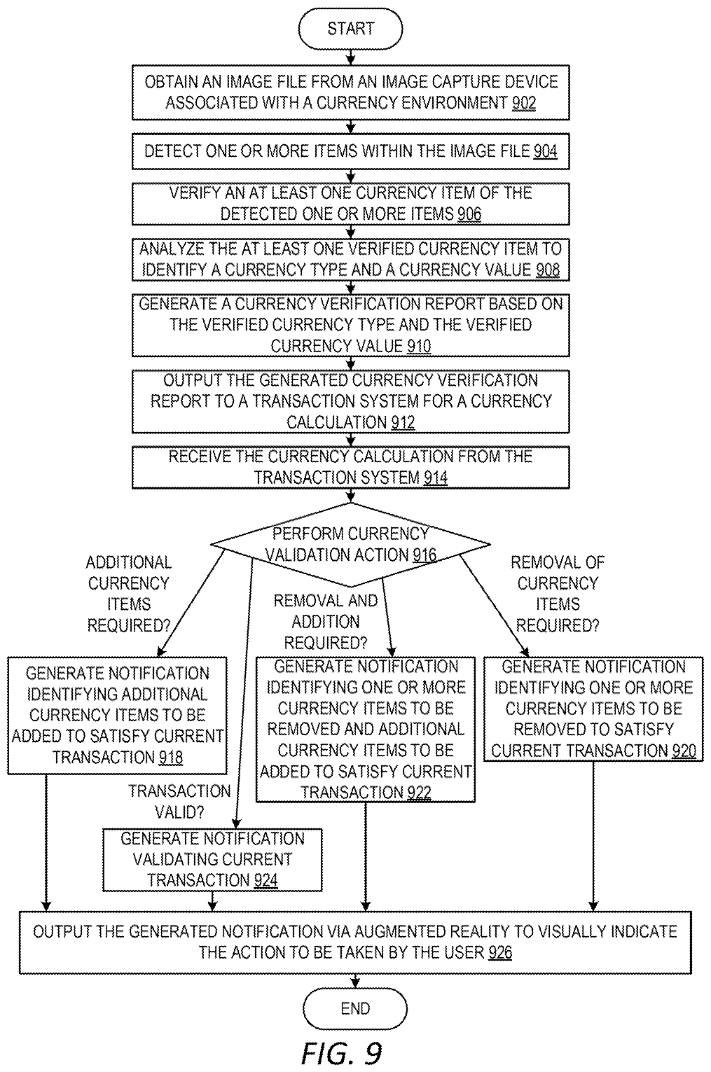

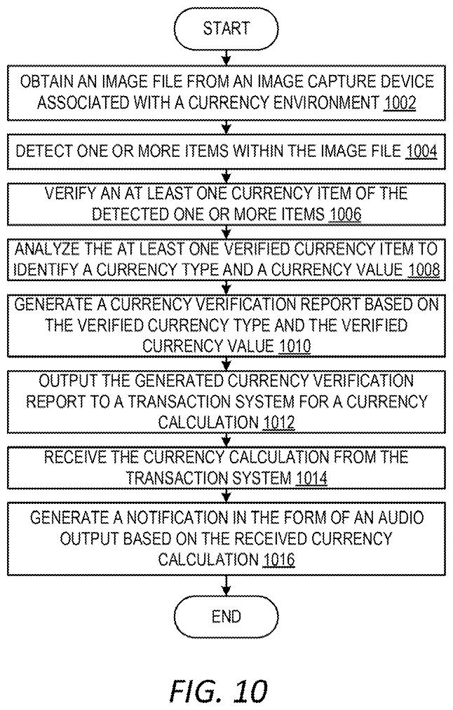

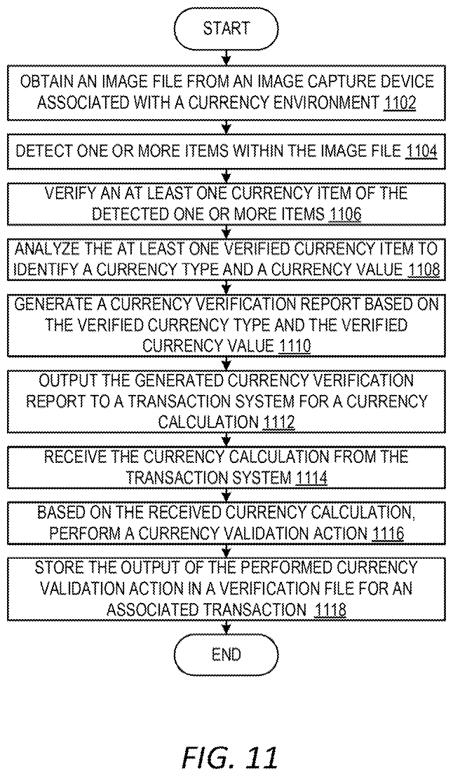

The processor 106 includes any quantity of processing units and is programmed to execute the computer-executable instructions 104. The computer-executable instructions 104 may be performed by the processor 106 or by multiple processors within the computing device 102 or performed by a processor external to the computing device 102. In some examples, the processor 106 is programmed to execute instructions such as those illustrated in the figures (e.g., FIG. 8, FIG. 9, FIG. 10, and FIG. 11).

The computing device 102 further has one or more computer readable media such as the memory 108. The memory 108 includes any quantity of media associated with or accessible by the computing device 102. The memory 108 may be internal to the computing device 102 (as shown in FIG. 1), external to the computing device 102 (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications may communicate with counterpart applications or services such as web services accessible via a network 112. For example, the applications may represent downloaded client-side applications that correspond to server-side services executing in a cloud.

In other examples, the user interface component 110 includes a graphics card for displaying data to the user and receiving data from the user. The user interface component 110 may also include computer-executable instructions (e.g., a driver) for operating the graphics card. Further, the user interface component 110 may include a display (e.g., a touch screen display or natural user interface) and/or computer-executable instructions (e.g., a driver) for operating the display. The user interface component 110 may also include one or more of the following to provide data to the user or receive data from the user: speakers 170, a sound card, a camera, a microphone, a vibration motor, one or more accelerometers, a BLUETOOTH® brand communication module, global positioning system (GPS) hardware, and a photoreceptive light sensor. For example, the user may input commands or manipulate data by moving the computing device 102 in a particular way.

The network 112 is implemented by one or more physical network components, such as, but without limitation, routers, switches, network interface cards (NICs), and other network devices. The network 112 may be any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface component 114. The communications interface component 114 includes a network interface card and/or computer-executable instructions (e.g., a driver) for operating the network interface card. Communication between the computing device 102 and other devices, such as but not limited to a user device 116 and/or one or more image capture device(s) 118, may occur using any protocol or mechanism over any wired or wireless connection. In some examples, the communications interface component 114 is operable with short range communication technologies such as by using near-field communication (NFC) tags.

The user device 116 represents any device executing computer-executable instructions 104 that is associated with a user 128. The user device 116 may be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 may also include a user interface component 144. In this example, the user device 116 may be an AR headset or other mobile computing device capable of generating an AR overlay over an image captured from an image capture device.

The image capture device(s) 118 are one or more devices for generating image file(s) 127 associated with the currency environment 180. The image capture device(s) 118 may be communicatively coupled to the network 112. An image capture device 118 may include a video camera and/or a still image camera, a set of video cameras and/or still image cameras, and/or a depth sensor for generating an image file 127 of at least one item in a plurality of detected items 152. In some examples, a set of image capture device(s) 126, which is functionally interchangeable with the image capture device(s) 118, is communicatively coupled directly to the computing device 102, without the network 112 being interposed between them. Unless otherwise stated, any description in this disclosure of the function of the image capture device(s) 118 applies equally to the set of image capture devices 126, and any description in this disclosure of the function of the set of image capture device(s) 126 applies equally to the image capture device(s) 118.

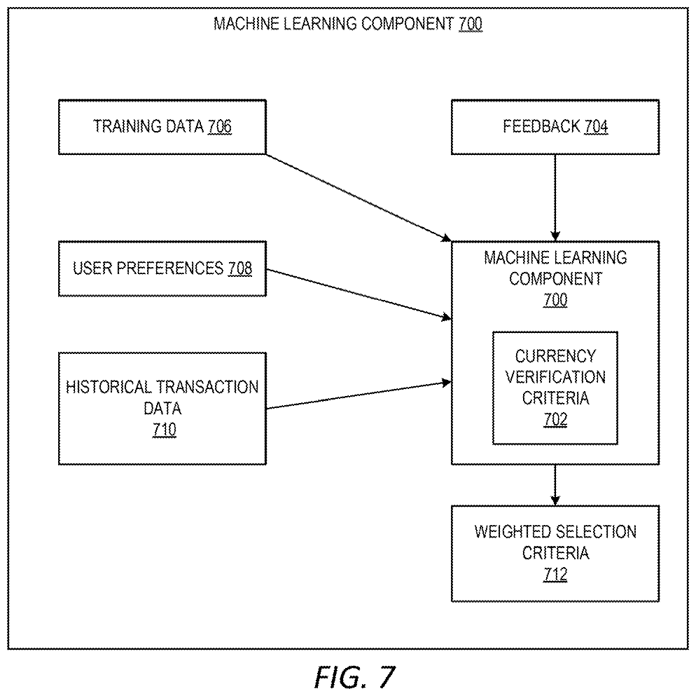

The system 100 may optionally include a data storage device 150 for storing data, such as, but not limited to, a plurality of image files 151; the plurality of detected items 152; a plurality of verified currency items 153; a plurality of currency calculations 154; a set of machine learning inputs 155; and a plurality of verification files 156. The set of machine learning inputs 155 may include, but are not limited to, training data, user preferences, historical transaction data, and a set of weighted selection criteria. The types and uses of the set of machine learning inputs 155 are discussed in further depth in the discussion of FIG. 7 below.

The data storage device 150 may include one or more different types of data storage devices, such as, for example, one or more rotating disks drives, one or more solid state drives (SSDs), and/or any other type of data storage device. The data storage device 150 in some non-limiting examples includes a redundant array of independent disks (RAID) array. In other examples, the data storage device 150 includes a database.

The data storage device 150 in this example is included within the computing device 102 or associated with the computing device 102. In other examples, the data storage device 150 is a remote data storage accessed by the computing device 102 via the network 112, such as a remote data storage device, a data storage in a remote data center, or a cloud storage.

The data storage device 150 in some non-limiting examples is utilized to aggregate data together for currency verification and transaction validation. The aggregated data may include the plurality of image files 151, the plurality of detected items 152, the plurality of verified currency items 153, the plurality of currency calculations 154, the set of machine learning inputs 155, the plurality of verification files 156, etc. This enables data utilized for currency verification and transaction validation to be aggregated into a single location for quick and efficient access by a currency identification component 122 and/or a verification and validation application 142 on the user device 116. In other examples, the data storage device 150 stores data identifying the various items within the currency environment 180. In yet other examples, such data is aggregated on a cloud storage device rather than a physical data storage associated with the currency environment 180.

The memory 108 in some examples stores one or more computer-executable components. Exemplary components include but are not limited to the currency identification component 122 and a transaction system 160. The transaction system 160 is, for example, any computing device, mobile device, dedicated hardware, or other component capable of functioning as a point of sale (POS) terminal for currency-based transactions.

The currency identification component 122 obtains the image file 127 from the image capture device 118 associated with the currency environment 180. The currency identification component 122 further detects one or more items within the image file 127, verifies at least one currency item of the detected one or more items; analyzes the at least one verified currency item to identify a currency type and a currency value; and generates a currency verification report 132 based on the verified currency type and the verified currency value. In this context, verifying an item means verifying that the currency item is of an appropriate type for the transaction presently being processed by the transaction system 160. This includes but is not limited to verifying that the item is indeed currency (either paper currency or coinage); that the item is the correct type of national currency (e.g., any United States-issued currency, but not Euros or other non-US currency, when the system 100 is configured to operate within the United States); that the item is legitimate (e.g., not counterfeit currency); and that the item is not a non-currency item (e.g., buttons, casino chips, arcade tokens, etc.).

The currency identification component 122 outputs the generated currency verification report 132 to the transaction system 160 for a currency calculation. The currency identification component 122 receives the currency calculation from the transaction system 160 and, based on the received currency calculation, performs a currency validation action from a set of currency validation actions 134. In some examples, the currency validation action is one of generating a notification identifying additional currency items to be added in order to satisfy a current transaction, generating a notification identifying one or more currency items to be removed in order to satisfy the current transaction, generating a notification identifying both the one or more currency items to be removed and the additional currency items to be added in order to satisfy the current transaction, generating a notification validating the current transaction, or generating a notification identifying unverified items to be removed.

In other examples, the currency validation action comprises generating a notification output audibly provided via a speaker device. The speaker device may be the speakers 170 of FIG. 1. Examples generating an audible notification output may be of particular use for enhancing transaction experiences for users 128 with visual impairments. In yet other examples, the output of the performed currency validation action is stored in a verification file for an associated transaction. The verification file may be one of the plurality of verification files 156 stored in the data storage device 150 of FIG. 1. In this context, the associated transaction refers to the transaction for which currency is presently being verified and calculated against the transaction total due so that the transaction may be validated. By storing the verification file for each validated transaction, the user 128 may maintain a correct log of all transactions validated. Such logs are often necessary to comply with industry standards for transaction audits and/or customer data security.

In some examples, the received currency calculation identifies a delta of a current transaction total and the at least one verified currency item. That is, in such examples the received currency calculation identifies the amount by which the at least one verified currency item differs from the transaction total, being either less than, greater than, or equal to the transaction total. When the delta is zero, indicating no difference between the transaction total and the at least one verified currency item, the transaction has been validated.

In some examples, the computing device 102 may further include or be communicatively coupled with an output component device 124. The output component device 124 may be the user interface component 110 of the computing device 102. The output component device 124 may output a portion of a currency environment 180 within a field of view (FOV) 140 of the user 128, as obtained by the image capture device 118 and including the plurality of detected items 152. This output may be a three-dimensional or two-dimensional image including real-world elements as well as virtual/graphical elements generated by the output component device 124. This output may also include or be determined by a currency validation action from the set of currency validation actions 134.

In other examples, the computing device 102 sends output to the user device 116 via the network 112. The verification and validation application 142 generates the output to be displayed on the user device 116, which may be a three-dimensional or two-dimensional image including real-world elements as well as virtual/graphical elements, based on the data received by the user device 116 from the computing device 102 via the network 112. The user interface component 144 on the user device 116 utilizes the output received from the computing device 102 to generate output displayed to the user 128. In some examples, the user device 116 may download the verification and validation application 142 from a web applications server via the network 112.

The computing device 102 performs currency verification and transaction validation using the image file(s) 127 captured from the image capture device(s) 118 associated with a currency environment 180. The user device 116 in some examples communicates with the computing device 102 or other local server on the Internet via web services application programming interface (API) management.

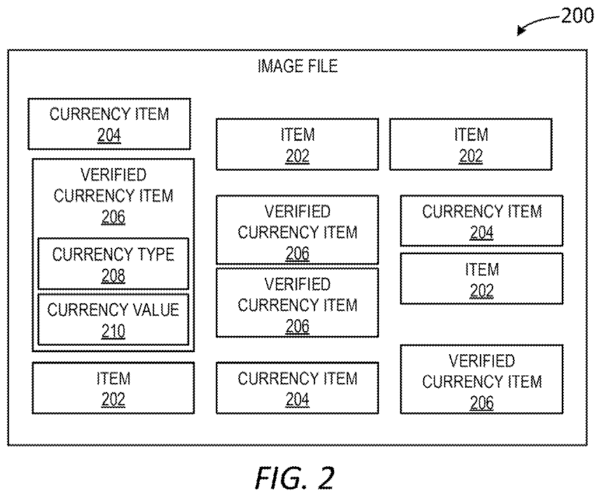

FIG. 2 is an exemplary block diagram illustrating the content of an example image file 200. For example, the image file 200 is the image file 127 of FIG. 1. FIG. 2 depicts the image file 200 after being processed by the currency identification component 122 of the system 100. The image file 200 may contain detected items 202. The detected items 202 may be any items that exist in the real world, including counterfeit currency, casino chips, public transportation tokens, and any other item of any type or kind which may or may not resemble actual currency. The image file 200 may also contain currency items 204, which may be paper currency or coin currency of any type or any amount or any country of origin. An example of the disclosure configured to verify United States currency and validate transactions using United States currency may therefore still be configured to recognize, for example, non-United States currency, if only to notify the user that such foreign currency must be removed before the present transaction may be validated and completed.

Verified currency items 206 have been verified by, for example, the currency identification component 122 of the system 100 of FIG. 1. Verified currency items 206 have been verified as real, authentic currency of the type the disclosure is configured to use to validate and complete a transaction. Each of the verified currency items 206 has been analyzed to determine a verified currency type 208 and verified currency value 210. The verified currency type 208 and verified currency value 210 for each of the verified currency items 206 may be used to generate the currency verification report in order to continue processing the transaction. In some examples, the user will be prompted to remove all the items 202 and currency items 204 which are not verified currency items 206.

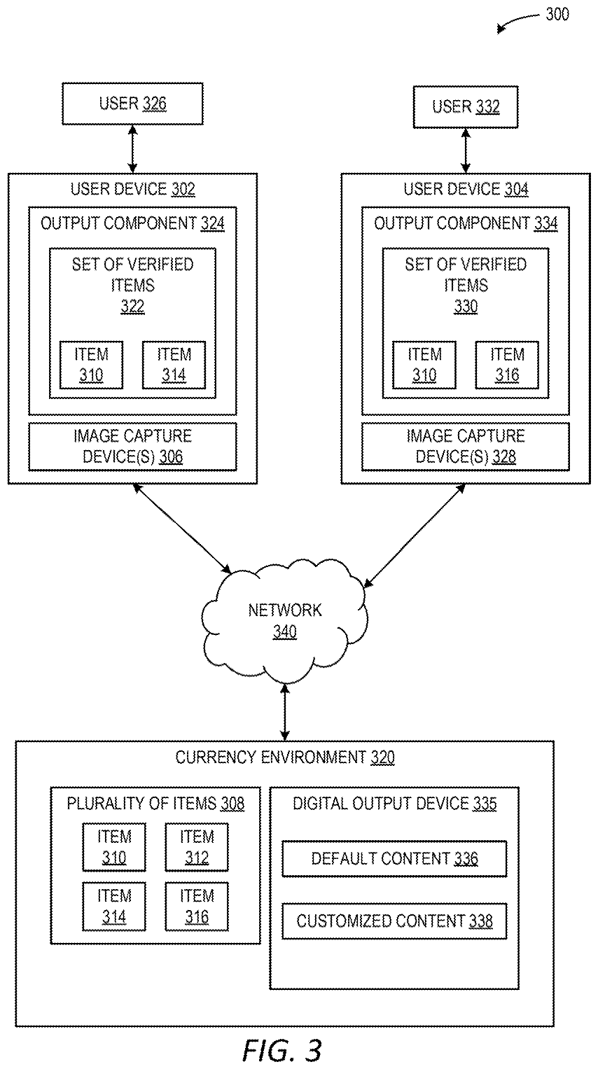

FIG. 3 is an exemplary block diagram illustrating a system 300 for performing currency verification and transaction validation via a user device, such as a user device 302. The user device 302 is associated with a user 326. Image capture device(s) 306 generates image file(s) associated with a plurality of items 308. The image file(s) may include image data (camera images) of the plurality of items 308 and a currency environment 320. The currency environment 320 is, for example, the currency environment 180 of FIG. 1. In one example, the currency environment may be a dedicated tray, or physical portion of a surface associated with a point-of-sale device. The plurality of items 308 includes items arranged in various positions within the currency environment 320, such as, but not limited to, an item 310, an item 312, an item 314, and an item 316. In some examples, the plurality of items 308 as depicted within the image file(s), including the item 310, the item 312, the item 314, and the item 316, may be the same types of items depicted within the example image file 200 in FIG. 2.

The verification and validation application analyzes the image file(s) generated by the image capture device(s) 306 to verify the items in the plurality of items 308 and validate the associated transaction. In some examples, the verification and validation application is the verification and validation application 142 from FIG. 1. In this example, the verification and validation application executing on the user device 302 generates a set of verified items 322, including items 310 and 314, but excluding items 312 and 316. The set of verified items 322 includes items verified and validated for the user 326. The set of verified items 322 are displayed on an output component 324. The output component 324 includes additional output generated by the user device 302 and may include information and/or instructions based on the current transaction and the last currency validation action performed. The output component 324 may be a component such as, but not limited to, the user interface component 144 in FIG. 1. The items excluded from the set of verified items 322 may be blocked, hidden, grayed out, obscured, or otherwise deleted/removed from the output component 324 to assist the user 326 in identifying items that are unnecessary to complete the present transaction. The output component 324 may instruct the user 326 to remove such items from the currency environment 320. Thus, in some examples the output component 324 hides or obscures non-currency items (e.g., buttons, lint, casino tokens, foreign currency, etc.) and non-verified currency items (e.g., otherwise appropriate currency items which cannot be verified because the currency items are damaged and thus unrecognizable). The output component 324 may also provide additional information associated with non-verified currency items (e.g., an explanation of why the currency item could not be verified, such as a counterfeit currency warning). Additional information may not be provided for verified currency items.

The image capture device(s) 328 on a different user device 304 associated with a different user 332 viewing the same plurality of items 308 generates image file(s) associated with the plurality of items 308. The user device 304 has an output component 334. The function and output of the user device 304 should be identical to the user device 302 given identical inputs, thus allowing the user devices 302 and 304 to be used interchangeably to conduct currency verification and transaction validation operations to complete a transaction, or to be used simultaneously to complete multiple transactions (e.g., at two separate POS locations). User preferences and/or transaction history data for the user 326 and or the user 332 may be used to adjust operation of the user device 302 and/or the user device 304. For example, user preferences and/or transaction history data are used to make adjustments to increase the accuracy of the currency verification and transaction validation process (e.g., to adjust the settings of image capture device(s) 306 and/or image capture device(s) 326 to accommodate local lighting conditions for optimum image capture).

In some examples, the currency environment 320 may include a digital output device 335. The digital output device 335 may include, without limitation, a light emitting diode (LED) display, a digital display, or any other type of digital output device. The digital output device 335 outputs default content 336, including item identifiers, item pricing information, item size information, promotional information, as well as any other default content. For example, whenever the digital output device 335 is not being used to verify currency and/or validate a transaction, the default content 336 may include advertisements meant to entice potential customers to purchase additional goods and/or services from the provider.

In other examples, the user device 302 sends customized content 338 to the digital output device 335 for output to the user 326 when the user device 302 detects the digital output device 335 within a predetermined range/distance of the user device 302. In other examples, the digital output device 335 displays customized content 338 received from the user device 302 for so long as the digital output device 335 detects the user device 302 within a predetermined range of the digital output device 335. A geofence area may be utilized to define the predetermined area. When the user device 302 is within the geofence area, the digital output device 335 displays the customized content 338 received from the user device 302. For example, if the user device 302 is within a geofence area associated with the digital output device 335, the digital output device 335 pings the user device 302 to request the customized content 338. In other examples, the user device 302 automatically sends the customized content 338 to the digital output device 335 in response to detecting/entering the geofence area. The digital output device 335 displays the customized content 338 as long as the user device 302 is within the geofence area. When the user device 302 is no longer within the geofence area, the digital output device 335 resumes display of default content 336.

The customized content 338 may include, but is not limited to, the result of the last currency validation action performed; content associated with local network status (e.g., network errors currently preventing currency from being verified and/or transactions being validated and completed); or other system status messages. In one example, the customized content 338 may include information associated with any of the items within the currency environment 320, such as the item 310 and/or the item 314.

When the user device 302 is no longer within the predetermined range of the digital output device 335, the digital output device 335 resumes displaying the default content 336. In other examples, when the user device 302 is detected within the predetermined range of the digital output device 335, the user device 302 sends customized content 338 associated with the item 310 and/or the item 316 to the digital output device 335. The digital output device 335 outputs the customized content 338 while the user device 304 is within range of the digital output device 335 for viewing by the user 332.

The customized content 338 may be sent to the digital output device 335 from the user device 302 via the network 340. The network 340 may include a BLUETOOTH®, a beacon transmitter, a LAN, a WAN, or any other type of network, such as, but not limited to, the network 112 in FIG. 1.

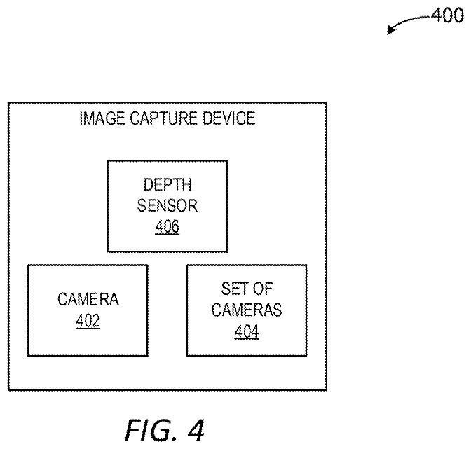

FIG. 4 is an exemplary block diagram illustrating an image capture device 400. The image capture device 400 may be any one of the image capture device(s) 118 or 126 from FIG. 1, or the image capture device(s) 306 or 328 from FIG. 3. In some examples, the image capture device 400 includes one or more of the following: a camera 402, a set of cameras 404, and a depth sensor 406. Whether all or any of the camera 402, the set of cameras 404, or the depth sensor 406 are included in the image capture device 400 depends on the configuration and intended use of the image capture device 400. Some cameras 402 are single-lens models. Other cameras 402 are multi-lens stereoscopic models. Examples featuring the camera 402 may include mobile phones, tablets, or personal computers equipped with non-specialized cameras, either as included hardware or add-on peripherals. While examples featuring the single-lens camera 402 may be the easiest and cheapest to acquire and deploy, implementable with off-the-shelf consumer-grade components, the nature of the flat, two-dimensional images captured by such cameras 402 may require application of more complex and/or computationally intensive computer vision and machine learning algorithms to successfully verify currency and validate transactions than might be required when using more specialized equipment.

Some examples of the image capture device 400 may include the set of cameras 404. use of the set of cameras 404 allows for capturing a given currency environment from offset points of view. For example, this enables capturing images which preserve information on stereoscopic depth within the currency environment. With stereoscopic depth information thus preserved, the disclosure may be configured to use computer vision and machine learning algorithms optimized to take advantage of this information, allowing for faster and more accurate currency verification and transaction validation.

Some other examples of the image capture device 400 may include the depth sensor 406. The depth sensor 406 (which may also be called a depth camera) in some examples is a laser coupled with a traditional two-dimensional camera, such as the camera 402. The depth sensor 406 is of particular importance in modern computer vision systems optimized for classification of three-dimensional items. While computer vision systems have historically performed sufficiently without the depth sensor 406 when the subject matter was essentially two-dimensional (e.g., recognition of handwriting on a flat surface), achieving reliable, accurate classification of three-dimensional items in three-dimensional space requires the ability to sense depth. Thus, in some examples, the depth sensor 406 is coupled with the traditional two-dimensional camera 402 to record and preserve depth information corresponding to an otherwise two-dimensional image. This is a simpler, more cost effective, and easier to implement solution than the stereoscopic set of cameras 404. Many modern mobile devices already include examples of the single-lens camera 402 coupled with the depth sensor 406, thus requiring no additional specialized equipment for accurate computer vision-based three-dimensional item classification.

In the context of currency verification and transaction validation, depth information, however recorded, is of particular importance in properly classifying coin currency. Coins are often distinguishable based on an individual coin's thickness and the topographical features of either side of the coin. In some examples, depth information may also enable the proper classification of a stack of coin currency wherein some of the features of each piece of coin currency may be at least partially obscured.

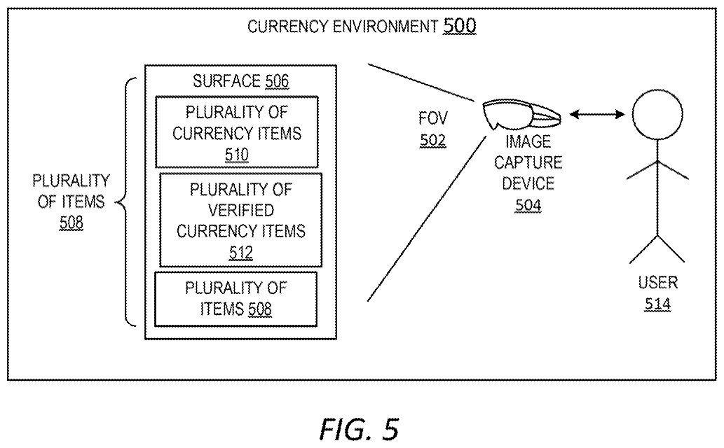

FIG. 5 is an exemplary block diagram illustrating a currency environment 500. In some examples, the currency environment 500 includes a field of view (FOV) 502 of an image capture device 504. The FOV 502 is, for example, the FOV 140 from FIG. 1. The image capture device 504 is, for example, one of the set of image capture device(s) 126 or one of the image capture device(s) 118 from FIG. 1. The FOV 502 may also be referred to as a scene, viewing range, or picture. The currency environment 500 is an area including a surface 506. Resting upon the surface 506 may be a plurality of items 508, a plurality of currency items 510, and a plurality of verified currency items 512. The currency environment 500 may include a store or other retail environment. The currency environment 500 may include an indoor area and/or an outdoor area having one or more items displayed for currency verification and transaction validation by one or more users.

The plurality of items 508 includes any type of items, such as, but not limited to, the plurality of detected items 152 in FIG. 1 and/or the items 202 in FIG. 2. The plurality of items 508 may be arranged in any order or pattern on the surface 506. The surface 506 may include a table, a desk, a kiosk, or any other space upon which the plurality of items 508 may be arranged such that they are within the FOV 502 of the image capture device 504.

A user 514 associated with the image capture device 504 views the output of the image capture device 504 that may include a real-world image of a portion of the currency environment 500 within the FOV 502 of the user 514 or the FOV 502 of the image capture device 504. This output may also include additional information relating to the present status of the currency verification and transaction validation operations for the present transaction. The image capture device 504 may be a computing device, such as, but not limited to, the computing device 102 in FIG. 1, the user device 116 in FIG. 1, and/or the user device 302 or 304 in FIG. 3. In this non-limiting example, the image capture device 504 may also be a set of AR glasses or an AR headset. In other examples, the image capture device 504 may include a tablet, cellular telephone, or other mobile computing device.

In some examples, the currency environment 500 includes one or more sensor devices (not shown) for identifying a location of the image capture device 504 within the currency environment 500. For example, the currency environment 500 may include image capture devices, beacon transmitters (not shown), beacon receivers (not shown), infrared (heat) sensors (not shown), proximity sensors (not shown), etc. The system in these examples analyzes the sensor data generated by the sensor device(s) to determine when an identified user is within proximity to a digital output device or other display area for customizing displayed content. For example, infrared (IR) sensor data is utilized for three-dimensional mapping of an area associated with the image capture device 504 to identify a location of the image capture device 504 within the currency environment 500 and/or to identify a plurality of items 508 located within a given range of the image capture device 504.

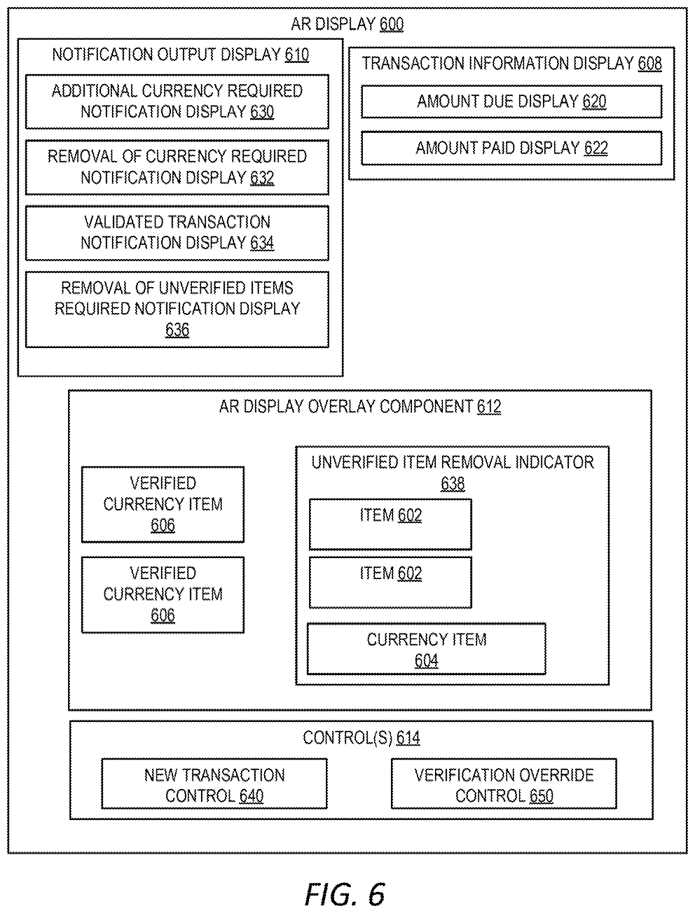

FIG. 6 is an exemplary block diagram illustrating an AR display 600 including various types of real-world items, including items 602, currency items 604, and verified currency items 606. The AR display 600 may be incorporated into the user interface component 144 of the user device 116 in FIG. 1, incorporated into the output component device 124 of FIG. 1, incorporated into the output component 324 of the user device 302 in FIG. 3, and/or incorporated into the output component 334 of user device 304 in FIG. 3. In some examples of the disclosure, the currency validation action comprises generating a notification output displayed on the AR display 600 via a computing device. In some examples, the computing device is the computing device 102 in FIG. 1.

In some examples, the AR display 600 is an AR headset worn by the user. The AR display 600 displays an image of the field of view of the currency environment corresponding to the field of view of the image capture device currently in use, overlaid with various virtual display elements providing output and user interface functionality to the user. These virtual display elements may include a transaction information display 608, a notification output display 610, an AR display overlay component 612, and control(s) 614.

The transaction information display 608 provides an overlay giving information on the current transaction the user is attempting to complete. This information may include an amount due display 620 and an amount paid display 622. The amount due display 620 displays the total amount of currency necessary to validate and complete the transaction. The amount paid display 622 shows the total amount of currency the system has already recognized and verified as being present. The notification output display 610 provides an overlay displaying the notification generated by the most recently performed currency validation action. This notification gives instructions to the user to continue the currency verification and transaction validation process. Thus, the notification output display 610 may provide an additional currency required notification display 630, a removal of currency required notification display 632, a validated transaction notification display 634, or a removal of unverified items required notification display 636.

The additional currency required notification display 630 may be shown when the user must provide more currency within the currency environment to validate and complete a transaction, in response to the last currency validation action. The additional currency required notification display 630 may include detailed instructions on which currency types must be provided, and in what amount. For example, if $7.63 is required to validate and complete a transaction, the additional currency required notification display 630 may notify the user to provide one five-dollar bill, two one-dollar bills, two quarters, one dime, and three pennies.

The removal of currency required notification display 632 may be shown when the user must remove currency from the currency environment to validate and complete a transaction, based on the last currency validation action. For example, if $15.00 is required to validate and complete a transaction and the user has provided a single twenty-dollar bill within the currency environment, the removal of currency required notification display 632 may notify the user to remove the twenty-dollar bill. In another example, $75.00 is required to validate and complete a transaction. If a user provides a single fifty-dollar bill and three ten-dollar bills, for a total of eighty dollars in verified currency, the removal of currency required notification display 632 may notify the user to remove only a single ten-dollar bill. The additional currency required notification display 630 may then notify the user to add a single five-dollar bill, or alternatively, five one-dollar bills.

The validated transaction notification display 634 may be shown when no further action by the user is required to validate and complete a transaction, based on the last currency validation action. For example, if $10.00 is required to complete the transaction and the user has provided two five-dollar bills within the currency environment, the validated transaction notification display 634 may notify the user that the transaction has been validated. Once this notification is delivered, the transaction is complete.

The removal of unverified items required notification display 636 may be shown when the user must remove unverified items from the currency environment to validate and complete a transaction. Such items may include currency items 604 which cannot be verified. For example, the currency items 604 may not be verified because the currency items 604 are damaged, foreign currency, or counterfeit currency. Unverified items may also include any other type of items 602.

The AR display overlay component 612 provides an overlay over all the real-world items within the field of view of the currency environment and is used to provide instructions to the user in visual form. An unverified item removal indicator 638 may be used to highlight any of the items 602 or unverified currency items 604 which the user must remove to continue verifying the currency validate and complete the current transaction. The AR display overlay component 612 may be updated in response to the notification output display 610 displaying any one of the additional currency required notification display 630, the removal of currency required notification display 632, the validated transaction notification display 634, or the removal of unverified items required notification display 636.

The control(s) 614 provide an overlay containing various user interface elements necessary to interact with the currency verification and transaction validation system. Which of the control(s) 614 are displayed may depend on the specific configuration the currency verification and transaction validation system. In some examples, a new transaction control 640 is displayed by the control(s) 614. The new transaction control 640 cancels the current transaction without completing currency verification and transaction validation operations and readies the system to begin a new transaction. In some other examples, a verification override control 650 is displayed by the control(s) 614. The verification override control 650 allows the user to override the system when it produces false negatives by failing to recognize certain items 602 as verified currency items 606, or alternatively recognizes items 602 as verified currency items 606 but assigns them the incorrect currency value. After activating the verification override control 650, the user may access certain user interface elements (not shown) enabling the user to manually indicate that the system should recognize certain items 602 as currency items 606 and assign the correct currency value to such currency items 606.

In some examples, an image of the content of AR display overlay component 612 indicating the state of all items 602 before and after the user completes all verification override operations is stored by the system. This image may be used, for example, for later review of the verification override event to ensure overriding the system was actually necessary and not a result of user mistake or wrongdoing. Such images may be recorded in a collection of verification files on a data storage device, such as the plurality of verification files 156 in the data storage device 150 in FIG. 1. In some examples, activation of the verification override control 650 generates feedback used for machine learning, as indicated in this disclosure's discussion of FIG. 7 below.

FIG. 7 is an exemplary block diagram illustrating a machine learning component 700. The machine learning component 700 analyzes currency verification criteria 702 using feedback 704, training data 706, user preferences 708, and/or historical transaction data 710.

The feedback 704 may include currency verification accuracy feedback, feedback associated with the efficiency of the currency validation action chosen based on the currency calculation, feedback associated with false negative identification of currency items as non-currency items or incorrect valuation of correctly identified currency items, and/or feedback associated with false positive identification of non-currency items as currency items. If the system accurately verifies currency, chooses efficient currency validation actions, and exhibits few or no false positive identifications, the feedback may be good. If the system performs inaccurate currency verifications, delivers a high number of false positives, or chooses inefficient currency validation actions, the feedback may be poor. In some examples incorporating the AR display 600, the feedback associated with false negative identification of currency items as non-currency items or incorrect valuation of correctly identified currency items is indicated by the user activating the verification override control 650 as illustrated in FIG. 6 and discussed in more detail in the above disclosure.

The user preferences 708 may include user-selected AR display preferences. For example, the user preferences 708 may include a user-selected colors for display of virtual elements within the AR display. In another example, the user preferences 708 may specify image capture optimizations to accommodate for local lighting conditions in order to create the most accurate image files.

The machine learning component 700 utilizes real-time data, such as the feedback 704, to adjust weights associated with each of the currency verification criteria 702. For example, if the currency verification criteria 702 indicate the user prefers the most accurate currency verification even at the expense of verification speed, the currency verification criteria 702 are weighted to indicate that accuracy should be prioritized over performance. In another example, if the currency verification criteria 702 indicate the user wants the most accuracy in the verification of coin currency even at the expense of accuracy in verification of paper currency, the currency verification criteria 702 are weighted to indicate that accuracy of coin currency recognition should have priority, even at the expense of less accurate recognition of paper currency.

The machine learning component 700 in some examples utilizes the feedback 704 from the user and the training data 706 associated with currency items to be recognized to adjust the currency verification criteria 702 weights. In the example above, if the user frequently interacts with certain types of currency, the machine learning component 700 may generate weighted selection criteria 712 indicating that the greatest preference should be given to attempting to recognize and verify those frequently encountered types of currency.

The currency verification criteria 702, the feedback 704, the training data 706, the user preferences 708, the historical transaction data 710, and/or the weighted selection criteria 712 may in some examples be stored in the set of machine learning inputs 155 within the data storage device 150 of the computing device 102 in FIG. 1.

In some examples, the machine learning component 700 comprises a trained regressor such as a random decision forest, directed acyclic graph, support vector machine, neural network, or other trained regressor. The trained regressor may be trained using the feedback 704 described above. Examples of trained regressors include a convolutional neural network and a random decision forest. It should further be understood that the machine learning module, in some examples, may operate according machine learning principles and/or techniques known in the art without departing from the systems and/or methods described herein.

FIG. 8 is an exemplary flow chart illustrating operation of the computing device to perform currency verification and transaction validation. The process shown in FIG. 8 may be performed by a currency identification component and a transaction system, executing on a computing device, such as the computing device 102, the currency identification component 122, the transaction system 160, and/or the user device 116 in FIG. 1.

The process begins by obtaining an image file from an image capture device associated with a currency environment at 802. A currency identification component implemented on a processor obtains the image file. The currency environment may also be referred to as a scene, viewing range, or picture. The currency environment refers to the portion of the real world about which the process may receive information in order to perform currency verification and transaction validation. In this example, that information is delivered in the form of an image file from an image capture device associated with the currency environment and capable of capturing still or video images of the currency environment. In some examples, the currency environment includes a field of view of the image capture device.

Depending on the contents of the image file, the currency identification component detects one of: no items within the image file; one or more items within the image file, of which no items are currency items; or one or more items within the image file, of which at least one item is a currency item. When one or more items are present within the image file, the one or more items are detected within the image file at 804. These items may include both currency items and non-currency items. The process verifies at least one currency item of the detected one or more items at 806 and analyzes the at least one verified currency item to identify a currency type and a currency value at 808. The process generates a currency verification report based on the verified currency type and the verified currency value at 810, and outputs the generated currency verification report to a transaction system for a currency calculation at 812.

In this context, verifying an item means verifying that the currency item is of an appropriate type for the transaction presently being processed by the transaction system. This includes but is not limited to verifying that the item is indeed currency (either paper currency or coin currency); that the item is the correct type of national currency (e.g., any United States-issued currency, but not Euros, when the process is operating within the United States); that the item is legitimate (e.g., not counterfeit currency); and that the item is not a non-currency item (e.g., buttons, casino chips, arcade tokens, etc.). The transaction system is, for example, any computing device, mobile device, dedicated hardware, or other component capable of functioning as a point of sale (POS) terminal for currency-based transactions.

The process receives the currency calculation from the transaction system at 814 and, based on the received currency calculation, performs a currency validation action at 816. In some examples, the received currency calculation identifies a delta of a current transaction total and the at least one verified currency item. That is, in such examples the received currency calculation identifies the amount by which the at least one verified currency item differs from the transaction total, being either less than, greater than, or equal to the transaction total. When the delta is zero, indicating no difference between the transaction total and the at least one verified currency item, the transaction has been validated. The process terminates thereafter.

In the examples where, after step 802, the currency identification component detects no items within the image file, or in the alternative detects no currency items within the image file, the process takes no further action and terminates immediately. No new currency verification report is generated, and no new currency verification report is sent to the transaction system. No new currency calculation nor new currency validation action are performed before the process terminates. When the process does terminate, the results and output of the last successful currency calculation and the last successful currency validation action are preserved. Thus, the state of the transaction currently being validated, as set by all the previous successful currency calculations and all the previous successful currency validation actions, is unchanged.

Such examples include scenarios where the image file is obtained while the currency environment is completely empty of items. This could indicate that the user accidentally started the process too early, or that the image capture device is improperly configured (e.g.: not oriented such that the FOV of the image capture device contains the currency area). In either scenario, the user should be able to quickly determine the reason that the process terminated after step 802 and rectify the issue.

Such examples also include scenarios where the image file is obtained while the currency environment is not completely empty of items, but the currency identification component detects only non-currency items. This result may occur when a user places an assortment of unidentified items in the currency environment, which contains no currency items. Thus, the identification component may detect whether any currency items are actually present. This result may also occur when foreign, fake, or counterfeit currency is detected within the currency environment. In this case, the system may allow for correction or may prevent the transaction from completing.

While the operations illustrated in FIG. 8 are performed by a computing device, aspects of the disclosure contemplate performance of the operations by other entities. For example, a cloud service may perform one or more of the operations.

FIG. 9 is an exemplary flow chart illustrating operation of the computing device to perform an appropriate currency validation action based on a currency calculation received from a transaction system. The process shown in FIG. 9 may be performed by a currency identification component and a transaction system, executing on a computing device, such as the computing device 102, the currency identification component 122, the transaction system 160, and/or the user device 116 in FIG. 1. Operations 902, 904, 906, 908, 910, 912, 914, and 916 of the process depicted in FIG. 9 are identical to operations 802, 804, 806, 808, 810, 812, 814, and 816 of the process depicted in FIG. 8.

In some examples, performing the currency validation action based on the received currency calculation further comprises, whenever additional currency is required to validate and complete a current transaction, generating a notification identifying the additional currency items to be added in order to validate and complete the current transaction at 918 and outputting the generated notification via augmented reality to visually indicate the additional currency items to be added at 926.

In other examples, performing the currency validation action based on the received currency calculation further comprises, whenever one or more currency items must be removed to validate and complete the current transaction, generating a notification identifying one or more currency items to be removed in order to validate and complete the current transaction at 920 and outputting the generated notification via augmented reality to visually indicate the one or more currency items to be removed at 926.

In still other examples, performing the currency validation action based on the received currency calculation further comprises, whenever both removal and addition of currency are required to validate and complete the current transaction, generating a notification identifying both the one or more currency items to be removed and the additional currency items to be added in order to validate and complete the current transaction at 922, and outputting the generated notification via augmented reality to visually indicate the one or more currency items to be removed and the additional currency items to be added at 926.

In yet other examples, performing the currency validation action based on the received currency calculation further comprises, whenever a transaction has been successfully validated, generating a notification validating the current transaction at 924, and outputting the generated notification via augmented reality to visually indicate the at least one identified currency item validates and completes the current transaction at 926.

The process terminates thereafter. For legibility, FIG. 9 refers to validating and completing a transaction as satisfying a transaction. Examples of how to use AR to output the generated notifications are provided in the discussion of FIG. 6 above and elsewhere in this disclosure. While the operations illustrated in FIG. 9 are performed by a computing device, aspects of the disclosure contemplate performance of the operations by other entities. For example, a cloud service may perform one or more of the operations.

FIG. 10 is an exemplary flow chart illustrating operation of the computing device to perform currency verification and transaction validation and to generate an audio output. The process shown in FIG. 10 may be performed by a currency identification component and a transaction system, executing on a computing device, such as the computing device 102, the currency identification component 122, the transaction system 160, and/or the user device 116 in FIG. 1. Operations 1002, 1004, 1006, 1008, 1010, 1012, and 1014 of the process depicted in FIG. 10 correspond to operations 802, 804, 806, 808, 810, 812, and 814 of the process depicted in FIG. 8.

In some examples, performing the currency validation action further comprises generating an audio output at 1016. The audio output includes at least one of a notification identifying additional currency items to be added in order to satisfy a current transaction, a notification identifying one or more currency items to be removed in order to satisfy the current transaction, a notification identifying both the one or more currency items to be removed and the additional currency items to be added in order to satisfy the current transaction, a notification validating the current transaction, or a notification identifying unverified items to be removed. Unverified items may be any non-currency item within the FOV of the currency environment.

The process terminates thereafter. The audio output used by this process may be the speakers 170 of the computing device 102 in FIG. 1. While the operations illustrated in FIG. 10 are performed by a computing device, aspects of the disclosure contemplate performance of the operations by other entities. For example, a cloud service may perform one or more of the operations.

FIG. 11 is an exemplary flow chart illustrating operation of the computing device to perform currency verification and transaction validation and to store the output in a verification file. The process shown in FIG. 11 may be performed by a currency identification component and a transaction system, executing on a computing device, such as the computing device 102, the currency identification component 122, the transaction system 160, and/or the user device 116 in FIG. 1. Operations 1102, 1104, 1106, 1108, 1110, 1112, 1114 and 1116 of the process depicted in FIG. 10 correspond to operations 802, 804, 806, 808, 810, 812, 814, and 816 of the process depicted in FIG. 8.

In some examples, the process further comprises storing the output of the performed currency validation action in a verification file for an associated transaction at 1118. The verification file may be one of the plurality of verification files 156 stored in the data storage device 150 of FIG. 1. In this context, the associated transaction refers to the transaction for which currency is presently being verified and the transaction is being validated against the transaction total due. By storing the verification file for each transaction for which currency is verified and the transaction validated, the user may maintain a correct log of all transactions processed for later reference. Such logs are often necessary to comply with industry standards for transaction audits and/or customer data security.

The process terminates thereafter. While the operations illustrated in FIG. 11 are performed by a computing device, aspects of the disclosure contemplate performance of the operations by other entities. For example, a cloud service may perform one or more of the operations.

### Additional Examples

In some examples, the currency identification component receives an amount of currency due from the transaction system. This amount due is sufficient to satisfy and validate, and thus complete, the current transaction. The machine learning and computer vision elements of the currency identification component take an image file of the currency environment as input and verify the type and amount of currency present in the currency environment. With this information available, the currency identification component determines what follow-up action is required to validate and complete the current transaction. Such follow-up actions are primarily in the form of removing or adding specified types of currency in specified amounts and may also include removing non-currency items. Examples of the disclosure notify the user of which follow-up action to take. Once the user takes such action, the process is repeated on a continuous loop until the correct type and amount of currency has been verified and the transaction has been validated and completed.

One example of the disclosure demonstrates a conventional computing device and image capture device, for example, the computing device 102 and image capture device 118, operating in an unconventional manner. A conventional computing device generally cannot compete with the speed and accuracy of a human being in the realm of image recognition and pattern matching. In contrast, the disclosure uses computer vision and machine learning techniques to enable a computing device, when programmed as described herein, to perform image recognition and pattern matching techniques in such a way as to meet or exceed the performance of a human being. The disclosure thus has a distinct advantage over a human being in the act of verifying the amount and type of currency presented by a customer to a provider of goods and/or services to validate and complete a transaction. When implemented on a computing device, the disclosure thereby improves the functioning of the computing device.

The modular nature of the disclosure, as well as the flexibility and versatility of the machine learning capabilities that provide the core of the currency verification and transaction validation features, allow for various alternative embodiments. For example, specialized machine learning techniques are used to teach examples of the disclosure how to detect and mark counterfeit currency. Because the presence of counterfeit currency may indicate possible criminal activity by the customer, the disclosure's potential to identify counterfeit currency provides a substantial benefit to public welfare and crime reduction efforts.

Another alternative embodiment builds on the disclosure's ability to identify which types of currency items, and in what amount, are required to fully validate and complete a transaction. Examples of the disclosure featuring any type of visual output are configured to display images of the required types and/or amounts of currency items. These images may be photorealistic or stylized so long as sufficient detail is provided. This extension would potentially increase transaction efficiency, as many users are quicker to identify familiar images than to read or listen to instructions necessary to complete a task.

Yet another alternative embodiment includes a suite of disability assistance/user accessibility aids. Examples of the disclosure configured to output audio notifications for the visually impaired have been discussed elsewhere in this disclosure. Alternative examples are configured to deliver notifications during the currency verification and transaction validation process via braille display or another type of tactile output. Such examples grant visually impaired customers and providers more confidentiality and privacy during transactions than a configuration dependent on an audio output.

Still another alternative embodiment provides the ability not only to identify foreign currency, but to simultaneously determine the appropriate conversion rate to convert the foreign currency into local currency. This embodiment is of particular use in environments where the provider of goods and/or services is able to accept both local and foreign currencies to validate and complete a transaction. Such environments may include international travel hubs (e.g., airports, train stations, etc.), travel accommodations which cater to international travelers, and money exchange/money transfer services (e.g., Western Union and other wire service providers).

The disclosure is adaptable to any type of image capture device which, at a minimum, can provide a two-dimensional image file depicting the currency environment. Thus, any type of image capture device meeting this threshold may be used, from the most simplistic of single-lens still cameras and scanners to the most advanced of depth sensor-equipped cameras and stereoscopic image capture devices. This flexibility gives the disclosure's image capture device(s) the potential to be customized to achieve optimum speed and/or accuracy for a given environment and/or verification and validation task.

Examples of the disclosure using AR features are configured to use any AR device, such as a headset, as an input/output device. Alternatively, such examples are configured to use an output device such as an LCD monitor communicatively coupled with a computing device and one or more image capture devices (e.g., an overhead camera) associated with the currency environment. When a non-AR input/output device combination (e.g., the LCD monitor and separate image capture device combination) is used, the virtual elements of the AR display may be layered over the image file captured from the image capture device and displayed on the non-AR output. Thus, the AR output may be delivered even when no dedicated AR input/output hardware is in use.

Examples of the disclosure using AR features are configured to provide a visual indication via AR overlay that a particular currency item has been verified and should not be removed. For example, a green checkmark is overlaid over a verified currency item. Verified currency items might also be given a color indicator and/or a highlighting outline. Such a configuration may increase transaction efficiency. Verified currency would be less likely to accidentally be removed and could also be more easily located and rearranged without being accidentally mixed with non-verified currency and non-currency items which need to be removed. Examples of the disclosure using AR features may also be configured to provide a visual indication via AR overlay that a particular item must be removed. Such indicators may include an “X” overlaid over the item, a color indicator, a highlighting outline, or a strike-though line.

In examples of the disclosure where a customer is provided a receipt by the transaction system upon successful validation of a transaction, the captured image used to successfully verify the currency and validate the transaction may be preserved. This preserved image may then be included with the receipt. Depending on the configuration of the transaction system, the receipt may be delivered on paper (e.g., via printout) or electronically (e.g., via email).

The disclosure enables providers of goods and/or services to quickly and accurately verify that the correct amount of currency is present to complete and validate a transaction, as well as that the customer has received the proper amount of change in return for an excess payment.

Examples of the disclosure optimized for working with large amounts of currency at a time may have particular benefits in environments where large amounts of currency must be exchanged at one time in a fast and accurate manner. Two such example environments might include certain banks and casinos.

Some examples of the disclosure are configured to verify any currency-like item that has distinct types and values within an environment, and validate transactions based on those currency-like items. Some potential environments include providers which offer coupons, providers which accept tokens (e.g., food stamps) or similar tokens which substitute for currency, casinos using a set of tokens in place of currency to securely facilitate betting, public transportation hubs which accept pre-purchased tokens as payment, and entertainment facilities whose attractions are activated via pre-purchased tokens. Other examples of the disclosure are used with coupons by visually verifying the coupon code entered at the point-of-sale (POS) matches the code on the coupon provided by the customer. Still other examples of the disclosure are configured to verify arcade tokens or raffle tickets. Yet other examples of the disclosure are configured to verify reward tokens submitted by a user to validate a transaction for a receipt of a prize. One example of a tokens-for-prize transaction includes verifying reward tokens submitted by a user to validate an exchange for a free stuffed animal.

Certain features of the disclosure herein may rely on certain computer vision and or machine learning techniques and technologies, and/or a combination thereof to obtain an image file from an image capture device associated with a currency environment; detect one or more items within the image file; verify at least one currency item of the detected one or more items; and analyze the at least one verified currency item to identify a currency type and a currency value. A number of such techniques and technologies may be used successfully to implement the disclosure herein, non-exhaustive examples of which are discussed in the following paragraphs.

Due to the different properties of coin currency and paper currency, different techniques and methodologies may be necessary for a single example of the disclosure to properly deal with both types of currency. The disclosure requires only that sufficiently capable computer vision and machine learning-powered currency recognition features be present and functional. The examples herein are thus provided only as illustrations, and do not represent an exclusive listing of all techniques and methodologies which may be suitable and applicable to the disclosure herein.

A Scale-Invariant Feature Transform (SIFT) algorithm may be used for recognition of both coinage and paper currency. SIFT produces distinct key-points and feature descriptors for each item in an image captured by an image capture device and is considered one of the most robust feature extraction algorithms. SIFT is a feature selection technique dependent on the appearance of the items to be recognized at specific interest points, which are not changed by image scale or rotation. SIFT deals effectively with changes in illumination, image noise, and minor changes in the image viewpoint. These features make it particularly well suited for implementation on a mobile image capture device such as a smartphone. SIFT is optimized for grayscale image capture but may take advantage of additional data available via color image capture to provide more accurate results. The SIFT algorithm may be implemented for currency recognition on a variety of platforms, including on JAVA® runtimes with the OpenCV computer vision/machine learning software library available.

An example currency recognition algorithm designed particularly for paper currency recognition uses a radial basis function network to classify the currency being examined. This method requires high-resolution image capture (e.g., from a digital camera), with the resulting image being converted first into greyscale and then black-and-white images. After such conversion is completed, the edge of the image is filtered using the Prewitt method and then detected using Canny's edge detection method. This image pre-processing serves to remove noise and distortions that may cause recognition errors. After this image pre-processing is complete, the image is analyzed for feature extraction. That is, a set of metadata is compiled about the image that can be used for a radial based neural network-powered pattern matching analysis. Gaussian radial basis functions are some of the most widely used types of radial basis functions in constructing radial based neural networks. A currency classifier built on top of such a radial basis function network may contain twenty-five neurons in the hidden layer. When an image is input, the recognition system calculates all the correlations between the image and known currency data template images, builds and trains the neural network, and finally classifies the type of currency in the inputted image.

Another example artificial neural network-based system, designed particularly for coin recognition, separates the entire process into seven distinct operations: acquisition of a color image from an image capture device; conversion of the color image to greyscale; removal of shadows from the image; cropping and trimming the image; generation of a pattern averaged image; generation of a feature vector which is passed as input to a trained neural network; and delivery of a recognition result to the user based on the output of the neural network. The shadow of the coin is removed by using the Hough transform algorithm for circle detection combined with the Sobel edge detection algorithm. The image is then cropped so that only the coin appears in the image and then trimmed to a size of 100×100 pixels. The trimmed and cropped image is used as input to the trained neural network. However, to reduce the computation and complexity in the neural network, the image is further reduced to a size of 20×20 pixels by segmenting the image using 5×5 pixel segments, and then taking the average of pixel values within the segment, to create a pattern averaged coin image. This pattern averaged coin image is used to generate a feature vector containing all the pixel values from the image. The vector is then passed to the trained neural network. Finally, the neural network processes the input and classifies the coin image to determine if it depicts a coin the neural network has been trained to recognize.

Many of the examples in this disclosure use an image capture device to capture a still image file associated with a currency environment for processing. That does not preclude the use of an image capture device associated with a currency environment and configured to capture a live video stream updated in real-time (a “real-time video capture device”). An example configured to use a real-time video capture device is able to obtain image files and perform more currency validation actions than a user could manually request in a given unit of time. Some examples configured to use a real-time video capture device may function identically to examples configured to capture and process a still image file, except that examples configured to use a real-time video capture device may effectively capture a single still image at a rate not exceeding the frame rate of the real-time video capture device. For example, a real-time video capture device configured to capture video at a rate of thirty frames per second (FPS) may effectively obtain up to thirty still image files every one second, even though some image files may be lost due to capture errors inherent in image capture technology such that the actual number of image files captured per second is less than the maximum possible amount. Each of these image files may then be individually processed as described herein to perform an appropriate currency validation action.

In such examples using a sufficiently high-performance processor and other components, images are captured, and currency verification and currency validation actions are performed at such great speed (e.g., in the above example, up to thirty times per second) that from the user's perspective a new currency validation action is performed instantaneously based on the user's actions. In such examples, where currency is verified and transactions are validated in apparent real-time, user efficiency may be maximized, and total transaction processing time may be minimized, allowing for an increased number of completed transactions validated per unit time, and a more pleasant experience for users. Where desirable (e.g., where only a less-powerful processor and or image capture device are available), an example is configured to capture and process fewer FPS (and thus, fewer image files per second) from a real-time video capture device. Such an example system may be configured to capture and process, for example, only five FPS, and thus, only five image files per second. However, even a reduced FPS configuration may still retain the advantage of increased transaction efficiency, if to a lesser degree than a configuration which appears to perform currency verification and transaction validation actions instantaneously based on the user's actions.

Alternatively, or in addition to the other examples described herein, examples include any combination of the following:
the image capture device includes one or more of the following: a camera, a set of cameras, and a depth sensor;
the currency environment includes a field of view of the image capture device;
the received currency calculation identifies a delta of a current transaction total and the at least one verified currency item;
the currency validation action is one of generating a notification identifying additional currency items to be added in order to satisfy a current transaction, generating a notification identifying one or more currency items to be removed in order to satisfy the current transaction, generating a notification identifying both the one or more currency items to be removed and the additional currency items to be added in order to satisfy the current transaction, generating a notification validating the current transaction, or generating a notification identifying unverified items to be removed;
the currency validation action comprises generating a notification output visually displayed in augmented reality via a computing device;
the currency validation action comprises generating a notification output audibly provided via a speaker device;
the output of the performed currency validation action is stored in a verification file for an associated transaction;
generating a notification identifying additional currency items to be added in order to satisfy a current transaction;
outputting the generated notification via augmented reality to visually indicate the additional currency items to be added;
generating a notification identifying one or more currency items to be removed in order to satisfy the current transaction;
outputting the generated notification via augmented reality to visually indicate the one or more currency items to be removed;
generating a notification identifying both the one or more currency items to be removed and the additional currency items to be added in order to satisfy the current transaction;
outputting the generated notification via augmented reality to visually indicate the one or more currency items to be removed and the additional currency items to be added;
generating a notification validating the current transaction;
outputting the generated notification via augmented reality to visually indicate the at least one identified currency item satisfies the current transaction;
generating an audio output, the audio output including at least one of a notification identifying additional currency items to be added in order to satisfy a current transaction, a notification identifying one or more currency items to be removed in order to satisfy the current transaction, a notification identifying both the one or more currency items to be removed and the additional currency items to be added in order to satisfy the current transaction, a notification validating the current transaction, or a notification identifying unverified items to be removed;
storing the output of the performed currency validation action in a verification file for an associated transaction; and/or
generating a notification, the notification including at least one of information identifying additional currency items to be added in order to satisfy a current transaction, information identifying one or more currency items to be removed in order to satisfy the current transaction, information identifying both the one or more currency items to be removed and the additional currency items to be added in order to satisfy the current transaction, information validating the current transaction, or information identifying unverified items to be removed.

At least a portion of the functionality of the various elements in FIG. 1, FIG. 2, FIG. 3, FIG. 4, FIG. 5, FIG. 6, and FIG. 7 may be performed by other elements in FIG. 1, FIG. 2, FIG. 3, FIG. 4, FIG. 5, FIG. 6, and FIG. 7, or an entity (e.g., processor 106, web service, server, application program, computing device, etc.) not shown in FIG. 1, FIG. 2, FIG. 3, FIG. 4, FIG. 5, FIG. 6 and FIG. 7.

In some examples, the operations illustrated in FIG. 8, FIG. 9, FIG. 10, and FIG. 11 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

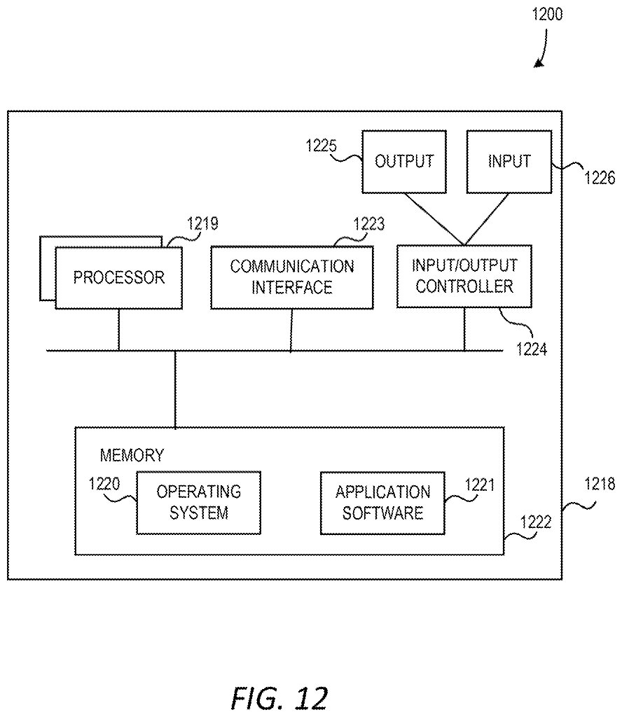

The present disclosure is operable with a computing apparatus according to an embodiment as a functional block diagram 1200 in FIG. 12. In an embodiment, components of a computing apparatus 1218 may be implemented as a part of an electronic device according to one or more embodiments described in this specification. The computing apparatus 1218 comprises one or more processors 1219 which may be microprocessors, controllers or any other suitable type of processors for processing computer executable instructions to control the operation of the electronic device. Platform software comprising an operating system 1220 or any other suitable platform software may be provided on the computing apparatus 1218 to enable application software 1221 to be executed on the device. According to an embodiment, currency verification and transaction validation as described herein may be accomplished by software.

Computer executable instructions may be provided using any computer-readable media that are accessible by the computing apparatus 1218. Computer-readable media may include, for example, computer storage media such as a memory 1222 and communications media. Computer storage media, such as a memory 1222, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 1222) is shown within the computing apparatus 1218, it will be appreciated by a person skilled in the art, that the storage may be distributed or located remotely and accessed via a network or other communication link (e.g. using a communication interface 1223).

The computing apparatus 1218 may comprise an input/output controller 1224 configured to output information to one or more output devices 1225, for example a display or a speaker, which may be separate from or integral to the electronic device. The input/output controller 1224 may also be configured to receive and process an input from one or more input devices 1226, for example, a keyboard, a microphone or a touchpad. In one embodiment, the output device 1225 may also act as the input device 1226. An example of such a device may be a touch sensitive display. The input/output controller 1224 may also output data to devices other than the output device, e.g. a locally connected printing device. In some embodiments, a user may provide input to the input device(s) 1226 and/or receive output from the output device(s) 1225.

The functionality described herein can be performed, at least in part, by one or more hardware logic components. According to an embodiment, the computing apparatus 1218 is configured by the program code when executed by the processor 1219 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for currency verification and transaction validation. For example, the elements illustrated in FIG. 1, FIG. 2, FIG. 3, FIG. 4, FIG. 5, FIG. 6 and FIG. 7, such as when encoded to perform the operations illustrated in FIG. 8, FIG. 9, FIG. 10, and FIG. 11, constitute exemplary means for obtaining, by a currency identification component implemented on a processor, an image file from an image capture device associated with a currency environment; exemplary means for detecting one or more items within the image file; exemplary means for verifying at least one currency item of the detected one or more items; exemplary means for analyzing the at least one verified currency item to identify a currency type and a currency value; exemplary means for generating a currency verification report based on the verified currency type and the verified currency value; exemplary means for outputting the generated currency verification report to a transaction system for a currency calculation; exemplary means for receiving the currency calculation from the transaction system; and exemplary means for, based on the received currency calculation, performing a currency validation action.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for currency verification and transaction validation, the system comprising:
a processor;
a memory communicatively coupled to the processor;
a currency identification component stored at the memory and executed by the processor to:
obtain an image file from an image capture device associated with a currency environment;
detect one or more items within the image file;
verify at least one currency item of the detected one or more items;
analyze the at least one verified currency item to identify a currency type and a currency value;
generate a currency verification report based on the verified currency type and the verified currency value;
output the generated currency verification report to a transaction system for a currency calculation;
receive the currency calculation from the transaction system; and
based on the received currency calculation, perform a currency validation action.

2. The system of claim 1, wherein the image capture device includes one or more of the following: a camera, a set of cameras, and a depth sensor.

3. The system of claim 1, wherein the currency environment includes a field of view of the image capture device.

4. The system of claim 1, wherein the received currency calculation identifies a delta of a current transaction total and the at least one verified currency item.

5. The system of claim 1, wherein the currency validation action is one of generating a notification identifying additional currency items to be added in order to satisfy a current transaction, generating a notification identifying one or more currency items to be removed in order to satisfy the current transaction, generating a notification identifying both the one or more currency items to be removed and the additional currency items to be added in order to satisfy the current transaction, generating a notification validating the current transaction, or generating a notification identifying unverified items to be removed.

6. The system of claim 1, wherein the currency validation action comprises generating a notification output visually displayed in augmented reality via a computing device.

7. The system of claim 1, wherein the currency validation action comprises generating a notification output audibly provided via a speaker device.

8. The system of claim 1, wherein the output of the performed currency validation action is stored in a verification file for an associated transaction.

9. A method for currency verification and transaction validation, the method comprising:
obtaining, by a currency identification component implemented on a processor, an image file from an image capture device associated with a currency environment;
detecting one or more items within the image file;
verifying at least one currency item of the detected one or more items;
analyzing the at least one verified currency item to identify a currency type and a currency value;
generating a currency verification report based on the verified currency type and the verified currency value;
outputting the generated currency verification report to a transaction system for a currency calculation;
receiving the currency calculation from the transaction system; and
based on the received currency calculation, performing a currency validation action.

10. The method of claim 9, wherein the currency environment includes a field of view of the image capture device.

11. The method of claim 9, wherein the received currency calculation identifies a delta of a current transaction total and the at least one verified currency item.

12. The method of claim 9, wherein performing the currency validation action further comprises:
generating a notification identifying additional currency items to be added in order to satisfy a current transaction; and
outputting the generated notification via augmented reality to visually indicate the additional currency items to be added.

13. The method of claim 9, wherein performing the currency validation action further comprises:
generating a notification identifying one or more currency items to be removed in order to satisfy the current transaction; and
outputting the generated notification via augmented reality to visually indicate the one or more currency items to be removed.

14. The method of claim 9, wherein performing the currency validation action further comprises:
generating a notification identifying both the one or more currency items to be removed and the additional currency items to be added in order to satisfy the current transaction; and
outputting the generated notification via augmented reality to visually indicate the one or more currency items to be removed and the additional currency items to be added.

15. The method of claim 9, wherein performing the currency validation action further comprises:
generating a notification validating the current transaction; and
outputting the generated notification via augmented reality to visually indicate the at least one identified currency item satisfies the current transaction.

16. The method of claim 9, wherein performing the currency validation action further comprises:
generating an audio output, the audio output including at least one of a notification identifying additional currency items to be added in order to satisfy a current transaction, a notification identifying one or more currency items to be removed in order to satisfy the current transaction, a notification identifying both the one or more currency items to be removed and the additional currency items to be added in order to satisfy the current transaction, a notification validating the current transaction, or a notification identifying unverified items to be removed.

17. The method of claim 9, further comprising:
storing the output of the performed currency validation action in a verification file for an associated transaction.

18. One or more computer storage media, having computer-executable instructions for currency verification and transaction validation that, when executed by a computer cause the computer to perform operations comprising:
obtaining, by a currency identification component implemented on a processor, an image file from an image capture device associated with a currency environment;
detecting one or more items within the image file;
verifying at least one currency item of the detected one or more items;
analyzing the at least one verified currency item to identify a currency type and a currency value;
generating a currency verification report based on the verified currency type and the verified currency value;
outputting the generated currency verification report to a transaction system for a currency calculation;
receiving the currency calculation from the transaction system; and
based on the received currency calculation, performing a currency validation action.

19. The one or more computer storage media of claim 18, wherein performing the currency validation action further comprises:
generating a notification, the notification including at least one of information identifying additional currency items to be added in order to satisfy a current transaction, information identifying one or more currency items to be removed in order to satisfy the current transaction, information identifying both the one or more currency items to be removed and the additional currency items to be added in order to satisfy the current transaction, information validating the current transaction, or information identifying unverified items to be removed.

20. The one or more computer storage media of claim 18, further comprising:
storing the output of the performed currency validation action in a verification file for an associated transaction.
